SEQUENCE LISTING (3 sequences)

SEQ ID NO: 1 - DNA, 528 bp, Sphingobacterium sp.
tggagagtttgatcctggctcaggatgaacgctagcggcaggcctaatacatgcaagtcggacgggatccagctggtagcttgctaccggttggtgagagtggcgcacgggtgcgtaacgcgtgagcaacctacccatatcagggggatagcccgaagaaattcggattaacaccgcatgacacarattkacmgcatggttkatttgtcaaatattcataggatatggatgggctcgcgtgacattagctagttggtggggtaacggcccaccaaggcgacgatgtctaggggctctgagaggagaatcccccacactggtactgagacacggaccagactcctacgggaggcagcagtaaggaatattggtcaatgggggcaaccctgaaccagccatgccgcgtgcaggatgactgccctatgggttgtaaactgcttttgttagggaataaaccccactacgtgtagtgggctgaatgtacctaaagaataaggatcggctaactccgtgccagcagccgcggta

SEQ ID NO: 2 - DNA, 522 bp, Achromobacter spanius
tggagagtttgatcctggctcagattgaacgctagcgggatgccttacacatgcaagtcgaacggcagcacggacttcggtctggtggcgagtggcgaacgggtgagtaatgtatcggaacgtgcctagtagcgggggataactacgcgaaagcgtagctaataccgcatacgccctacgggggaaagcaggggatcgcaagaccttgcactattagagcggccgatatcggattagctagttggtggggtaayggctcaccaaggcgacgatccgtagctggtttgagaggacgaccagccacactgggactgagacacggcccagactcctacgggaggcagcagtggggaattttggacaatgggggaaaccctgatccagccatcccgcgtgtgcgatgaaggccttcgggttgtaaagcacttttggcaggaaagaaacgtcatgggctaataccycgtgaaactgacggtacctgcagaataagcaccggctaactacgtgccagcagccgcggta

SEQ ID NO: 3 - DNA, 351 bp, Trichosporon dermatis
gcatcgatgaagaacgcagcgaaatgcgataagtaatgtgaattgcagaattcagtgaatcatcgaatctttgaacgcaacttgcgctctctggtattccggagagcatgcctgtttgagtatcatgaaatctcaaccattagggtttcttaatggcttggatttgggcgctgccacttgcctggctcgccttaaaagagttagcgtattaacttgtcgatctggcgtaataagtttcgctggtgtagacttgagaagtgcgcttctaatcgtcttcggacaattcttgaactctggtctcaaatcaggtaggactacccgctgaacttaagcatatcaataagcggagga

(19) United States
(12) Patent Application Publication
(10) Pub. No.: US 2016/0137561 A1
(43) Pub. Date: May 19, 2016

(54) LOCALLY SOURCED MICROORGANISMS USEFUL FOR COMPOSTING PLASTIC TRASH

(71) Applicant: John Dorlandt Wood, Manhattan Beach, CA (US)

(72) Inventor: John Dorlandt Wood, Manhattan Beach, CA (US)

(21) Appl. No.: 14/985,884

(22) Filed: Dec. 31, 2015

(51) Int. Cl. C05F 17/00

(52) U.S. Cl. CPC C05F 17/0036

(57) ABSTRACT

Plastic human waste is a growing threat to today's environment. A simple and viable method of reducing the mass of waste in landfills is using microbial organisms to decompose plastics that would otherwise add to the accumulation of garbage. Presented here is the discovery of three microorganisms having the ability to degrade polyurethane plastics. Methods for composting polyurethane using these microorganism can help reduce amounts of human trash.

### TECHNICAL FIELD

The field of this invention is bioremediation, in particular the use of microorganisms to compost polyurethane plastic trash.

### BACKGROUND OF THE INVENTION

As the use of plastics like polyurethane has increased throughout the world, a problem has arisen: how to properly dispose of the trash formed from these materials. Currently, there are two major methods of keeping these materials out of landfills: recycling and incineration. While recycling is good, because the growth in the use of the plastics is greater than the growth of recycling technologies, other methods are needed. This is why some turn to burning waste. However, this solution presents its own problems, as the gas and heat produced from this contribute to global climate change.

In this search for efficient and environmentally clean methods for the decomposition of plastics, no current procedure of doing so fulfills both requirements, forcing us to choose between effectiveness and environmental friendliness. This is where a third option presents itself: bioremediation, the use of naturally occurring microorganisms to break down man-made forms of waste. This third option balances ecologically friendly techniques with costs and efficiency.

Bioremediation relies on biological processes to break down human pollutants like plastic bags and bottles, many of which are made from polyurethane materials. However, one problem that arises with bioremediation is that of finding ideal organisms to consume the plastic waste. Ideal microorganisms for this are those that are present in the local environment where the plastics will be degraded. Locally sourced microorganisms like those already present in soils and decomposing organic matter are ideal because they are best suited to compost in that environment and also do not risk possible problems from the introduction of potentially invasive non-native species into new environments.

### SUMMARY OF THE INVENTION

In order to identify microorganisms that can break down polyurethane materials, I took microorganisms found in composting organic matter from Manhattan Beach, Calif. and screened them for their ability to degrade polyurethane. This screen identified three microorganisms that can degrade polyurethane: two bacteria and one fungus. One of the bacteria is a new species of Sphingobacterium, and the other is Achromobacter spanius. The fungal species is Trichosporon dermatis/mucoides. These microorganisms can be used in methods that facilitate the biodegradation of polyurethane plastic waste. The methods described below for composting polyurethane using these microorganisms can help reduce amounts of human plastic trash such as that found in landfills.

The described microorganisms are useful in methods for composting polyurethane trash. This can be done by combining polyurethane trash with compostable organic matter such as leaves, stems, roots, fruits, seeds etc. In one specific example, compostable matter is mixed with polyurethane trash such as a polyurethane bag or bottle and a Sphingobacterium species that can utilize polyurethane as a sole carbon source. This compost combination is then mixed periodically and exposed to conditions suitable for microbial degradation of the combination of organic matter and polyurethane. These conditions include the climate found in Manhattan Beach Calif., latitude 33.884736 and longitude −118.410909. The organic matter can additionally or alternatively be mixed with an Achromobacter spanius and/or a Trichosporon dermatis/mucoides microorganism that can utilize polyurethane as a sole carbon source so that multiple polyurethane degrading microorganisms are used to compost. While a variety of composting systems can use these microorganisms, all three microorganisms were observed to grow well and degrade polyurethane within a rotatable composting container that was rotated at least once a week.

A commercial embodiment of the invention is a polyurethane composting kit that contains a seed culture of live polyurethane degrading organism(s). The composting kit can, for example, include a handful of leaves or other composting material that have been coated with a culture of Sphingobacterium and/or Achromobacter spanius and/or Trichosporon dermatis/mucoides, along with instructions on how to use these microorganisms to compost with polyurethane. These polyurethane compositing kits can be sold online, and at gardening stores and nurseries that sell conventional composting supplies.

### BRIEF DESCRIPTION OF THE DRAWINGS

FIGS. 1A and 1B provide schematic drawings showing how polyurethane degrading microorganisms change liquid polyurethane only medium from its initial opaque appearance (1A) to clear (1B).

FIGS. 2A and 2B provide shows how polyurethane degrading microorganisms change a zone of petri dish medium from its initial opaque appearance (2A) to clear (2B).

FIG. 3 provides the results of a Charles Rivers Laboratories Accugenix database search on the DNA sequence shown in SEQ ID NO: 1, which identified it as coming from a bacteria in the Sphingobacterium genus, as well as DNA sequence alignment with related microorganisms, and a neighbor joining tree showing the relatedness of these microorganisms.

FIG. 4 provides the results of a Charles Rivers Laboratories Accugenix database search on the DNA sequence shown in SEQ ID NO: 2, which identified it as coming from Achromobacter spanius, as well as DNA sequence alignment with related microorganisms, and a neighbor joining tree showing the relatedness of these microorganisms.

FIG. 5 provides the results of a Charles Rivers Laboratories Accugenix database search on the DNA sequence shown in SEQ ID NO: 3, which identified it as coming from Trichosporon dermatis, as well as DNA sequence alignment with related microorganisms, and a neighbor joining tree showing the relatedness of these microorganisms.

### DETAILED DESCRIPTION OF THE INVENTION

Polyester polyurethane is a plastic widely used in industry and manufacturing that has been shown to be susceptible to biodegradation. The invention involves harnessing the power of local microorganisms to degrade polyurethane trash, such as disposable polyurethane bottles or bags. As discussed in detail below, a number of organisms growing on sheets of synthetic polymer polyester polyurethane that had been mixed with composting plant matter from Manhattan Beach Calif. were tested for their ability to degrade polyurethane in both solid and liquid cultures. These tests resulted in the identification of three microbial species as having an ability to break down polyurethane, two bacteria and one fungus.

The strategy used to isolate these organisms was adapted from Russell et al., APPLIED AND ENVIRONMENTAL MICROBIOLOGY, September 2011, p. 6076-6084, which examined microorganisms collected in the Yasuni National Forest in the Ecuadorian Amazonian rainforest.

Initially, sheets of synthetic polymer polyester polyurethane were mixed with garden plant matter and soil from Manhattan Beach Calif. and composted in a rotatable composter for six weeks, with the compost being mixed at least once a week. After six weeks, organisms found on these sheets were screened for their ability to degrade polyurethane using a microbial growth media that included polyurethane as a sole carbon source.

The media used to isolate the microorganisms was prepared by the microbial media company TEKNOVA following the media recipes found in Russell et al., APPLIED AND ENVIRONMENTAL MICROBIOLOGY, September 2011, p. 6076-6084. This custom media used Impranil DLN as a food/carbon source for the microorganisms. Impranil DLN is a polyester polyurethane that forms a opaque milky suspension that becomes transparent upon degradation. If an organism grows in the Impranil DLN media, this means that it can use polyurethane as the sole carbon source for metabolism and growth. Organisms capable of degrading this polymer display a zone of clearance around the growing culture. Using this polyurethane media, organisms were screened for their ability to degrade polyurethane in both liquid (flask) and solid (petri dish) cultures.

Microorganisms were assayed for their ability to degrade polyurethane by inoculating a liquid polyurethane medium with a small piece of a polyurethane sheet and growing them in this media, media that included Impranil DLN as an anionic aliphatic aqueous polyurethane dispersion (Bayer MaterialScience). Other test samples were dabbed from a polyurethane sheet onto and grown on solid medium in petri dishes. The custom media contained 19 mM NaH2PO4, 33.5 mM K2HPO4, 7.6 mM (NH4)2SO4, 2.5 mM Na citrate, 250 μM MgSO4, 19 μM thiamine, 147 μM FeCl3 [symbol] 6H2O, 14 μM ZnCl2 [symbol] 4H2O, 12 μM CoCl2 [symbol] 6H2O, 12 μM Na2MoO4 [symbol] 2H2O, 10 μM CaCl2 [symbol] 2H2O, 11 μM CuCl2, 12 μM MnCl2, 12 μM H3BO3, and 1.8 mM HCl. To 1 liter of this mixture was added 10 ml Impranil DLN. For solid assays, 15 g/L of agar was added to this medium.

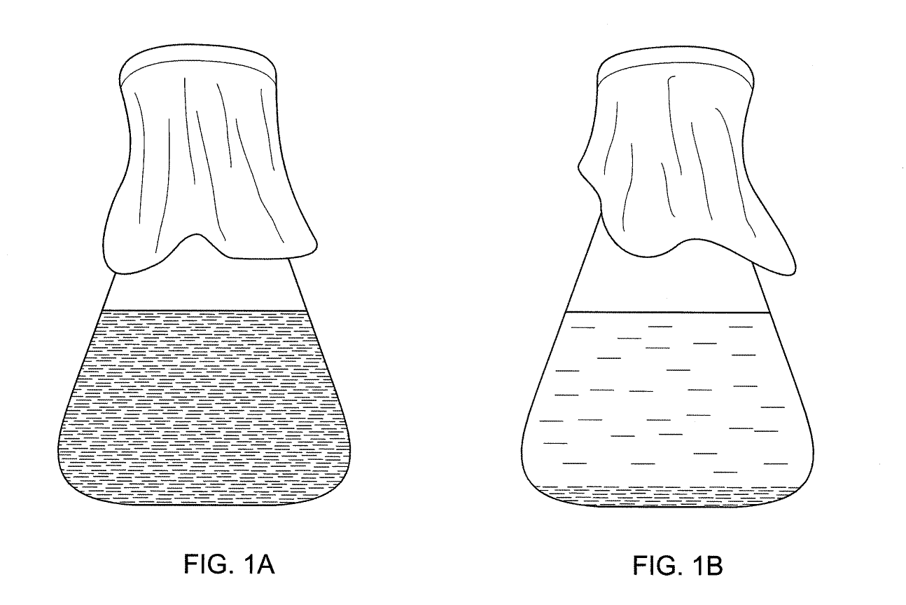

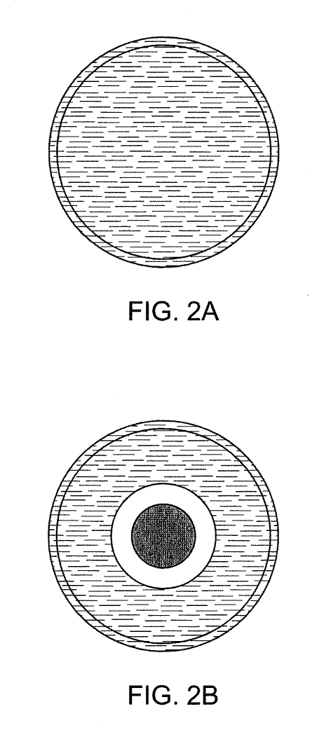

FIG. 1 diagrams how polyurethane degrading microorganisms change liquid polyurethane medium from its initial opaque appearance (FIG. 1A) to a translucent one (FIG. 1B). For the solid medium screening assay polyurethane solid medium was blotted with composted polyurethane sheets and then grown at 37 C for 1 week. Polyurethane degradation was evidenced by a change in the petri dish medium appearance from opaque to a translucent one. FIG. 2 diagrams how polyurethane degrading microorganisms change petri dish medium from its initial opaque appearance (FIG. 2A) to a translucent appearance (FIG. 2B). Organisms that have the ability to change the medium appearance in this way were isolated as pure cultures using a streak plate method. This isolation method involves the dilution of microorganisms by systematically streaking them over the exterior of the agar in a petri dish to obtain isolated colonies of identical microorganisms.

DNA sequencing and phylogenetic analysis of the isolated microorganisms was performed by Charles Rivers Laboratories using their AccuGENX-ID® system. This involves comparative DNA sequencing portions of the 16S rRNA gene in bacteria or portions of the internal transcribed spacer (ITS) 2 rRNA region in fungi, DNA regions which are recognized as an accurate and reproducible marker for identifying unknown microorganisms. The DNA sequence information from microorganism samples was then compared to DNA sequences in a library of known DNA sequences from different microorganisms. Charles Rivers genotypic analysis process adheres to the reference method used by taxonomists and DNA sequence data for identifications.

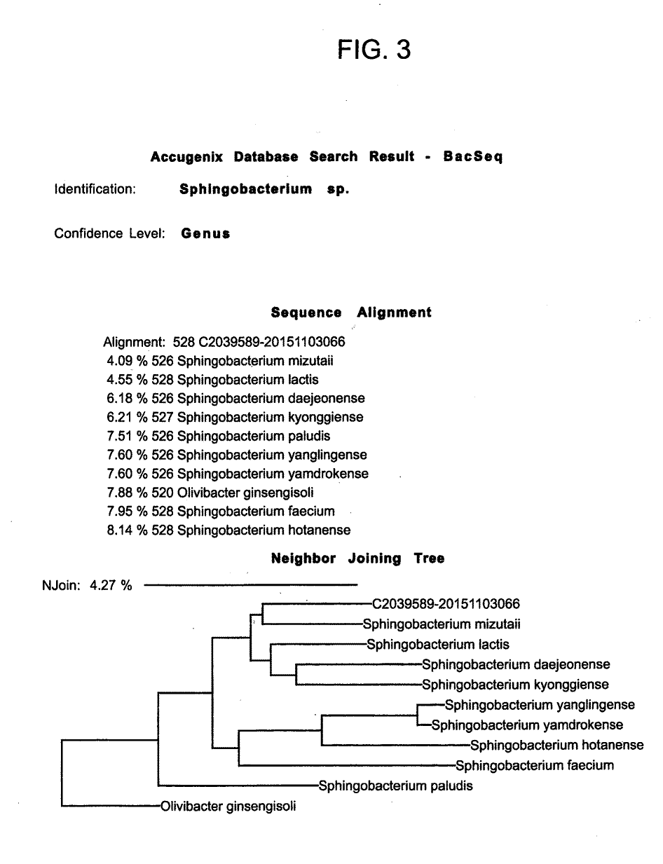

Six microorganism samples that had been isolated in polyurethane media and then grown into pure cultures had their DNA examined by Charles Rivers Laboratories using their AccuGENX-ID® system. These tests identified three unique microorganisms that are able to degrade polyurethane: a new Sphingobacterium species, Achromobacter spanius, and Trichosporon dermatis. The three DNA sequences from these microorganisms are shown below. The identity and phylogenetic tree for the three microorganisms are shown in FIGS. 3, 4 and 5.

A typical example of the invention is a kit that contains a seed culture of live polyurethane degrading organism(s) for use in composting. For example, a small composting kit (e.g. one weighing less than 10, 5, or 1 kilogram(s)) that includes a composition of matter comprising a Sphingobacterium (identified as a Sphingobacterium by having the DNA sequence found in the text below that is designated “SEQ ID NO: 1”), and/or Achromobacter spanius (identified as Achromobacter spanius by having the DNA sequence found in the text below that is designated “SEQ ID NO: 2”) and/or Trichosporon dermatis (identified as Trichosporon dermatis by having the DNA sequence found in the text below that is designated “SEQ ID NO: 3”). The composition in this kit can be designed to include some significant number of live organisms, for example at least 10,000 live microorganisms of the useful species.

Microorganisms that Degrade Polyurethane

1. New Bacterial Species within the Sphingobacterium Genus

This microbe from the garden compost/polyurethane mix that was identified as being able to degrade polyurethane was designated test sample “C2039589-20151103066” by Charles

River Laboratories. Charles River Laboratories DNA sequencing tests show that it is a previously unknown species of bacteria within the Sphingobacterium genus (see FIG. 3). This microorganism was identified by obtaining and sequencing its DNA, which showed that it includes the following DNA sequence:

(SEQ ID NO: 1)

TGGAGAGTTTGATCCTGGCTCAGGATGAACGCTAGCGGCAGGCCTAATAC
ATGCAAGTCGGACGGGATCCAGCTGGTAGCTTGCTACCGGTTGGTGAGAG
TGGCGCACGGGTGCGTAACGCGTGAGCAACCTACCCATATCAGGGGGATA
GCCCGAAGAAATTCGGATTAACACCGCATGACACARATTKACMGCATGGT
TKATTTGTCAAATATTCATAGGATATGGATGGGCTCGCGTGACATTAGCT
AGTTGGTGGGGTAACGGCCCACCAAGGCGACGATGTCTAGGGGCTCTGAG
AGGAGAATCCCCCACACTGGTACTGAGACACGGACCAGACTCCTACGGGA
GGCAGCAGTAAGGAATATTGGTCAATGGGGGCAACCCTGAACCAGCCATG
CCGCGTGCAGGATGACTGCCCTATGGGTTGTAAACTGCTTTTGTTAGGGA
ATAAACCCCACTACGTGTAGTGGGCTGAATGTACCTAAAGAATAAGGATC
GGCTAACTCCGTGCCAGCAGCCGCGGTA

In view of the manner in which it was isolated, the name Sphingobacterium viridi deserta is proposed for this new species of bacteria (“viridi deserta” is Latin for green waste).

### 2. Achromobacter Spanius

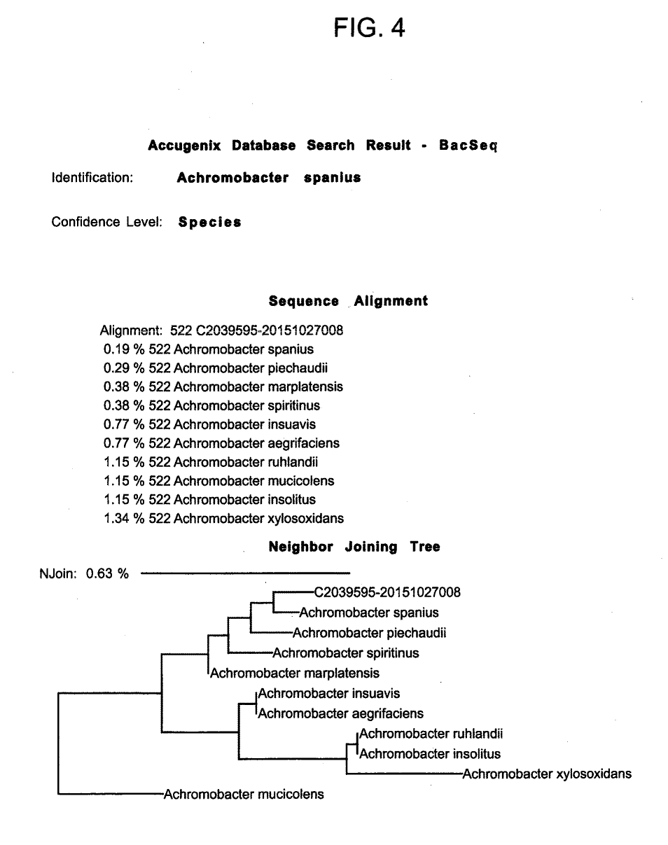

This microbe from the garden compost/polyurethane mix that was identified as being able to degrade polyurethane was designated test sample “C2039595-20151027008” by Charles River Laboratories. Charles River Laboratories DNA sequencing tests show that it is the bacterial species Achromobacter spanius (see FIG. 4). This microorganism was identified by obtaining and sequencing its DNA, which showed that it includes the following DNA sequence:

(SEQ ID NO: 2)

TGGAGAGTTTGATCCTGGCTCAGATTGAACGCTAGCGGGATGCCTTACAC
ATGCAAGTCGAACGGCAGCACGGACTTCGGTCTGGTGGCGAGTGGCGAAC
GGGTGAGTAATGTATCGGAACGTGCCTAGTAGCGGGGGATAACTACGCGA
AAGCGTAGCTAATACCGCATACGCCCTACGGGGGAAAGCAGGGGATCGCA
AGACCTTGCACTATTAGAGCGGCCGATATCGGATTAGCTAGTTGGTGGGG
TAAYGGCTCACCAAGGCGACGATCCGTAGCTGGTTTGAGAGGACGACCAG
CCACACTGGGACTGAGACACGGCCCAGACTCCTACGGGAGGCAGCAGTGG
GGAATTTTGGACAATGGGGGAAACCCTGATCCAGCCATCCCGCGTGTGCG
ATGAAGGCCTTCGGGTTGTAAAGCACTTTTGGCAGGAAAGAAACGTCATG
GGCTAATACCyCGTGAAACTGACGGTACCTGCAGAATAAGCACCGGCTAA
CTACGTGCCAGCAGCCGCGGTA

3. Trichosporon dermatis/mucoides

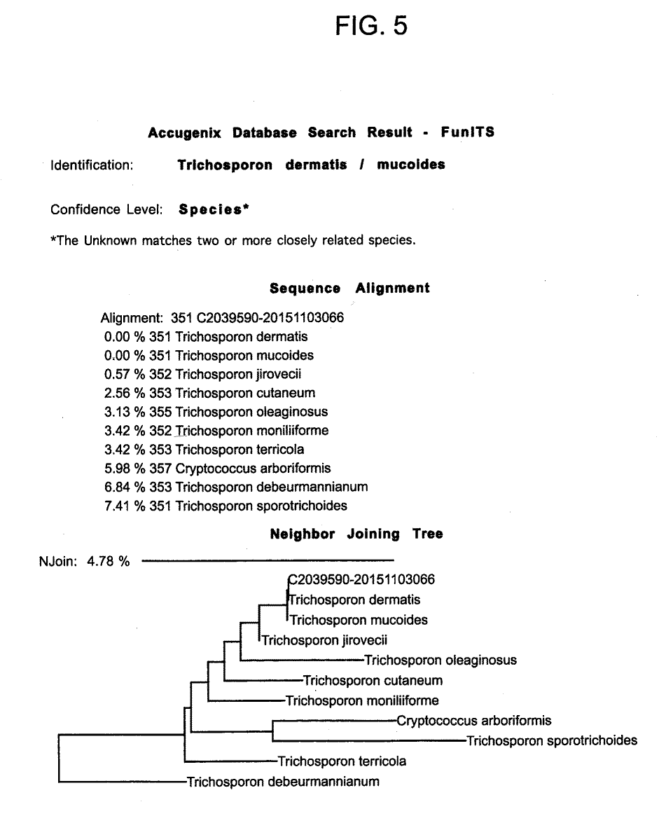

This microbe from the garden compost/polyurethane mix that was identified as being able to degrade polyurethane was designated test sample “C2039590-20151103066” by Charles River Laboratories. Charles River Laboratories DNA sequencing tests show that it is the fungal species Trichosporon dermatis/mucoides (see FIG. 5). This microorganism was identified by obtaining and sequencing its DNA, which showed that it includes the following DNA sequence:

(SEQ ID NO: 3)

GCATCGATGAAGAACGCAGCGAAATGCGATAAGTAATGTGAATTGCAGAA
TTCAGTGAATCATCGAATCTTTGAACGCAACTTGCGCTCTCTGGTATTCC
GGAGAGCATGCCTGTTTGAGTATCATGAAATCTCAACCATTAGGGTTTCT
TAATGGCTTGGATTTGGGCGCTGCCACTTGCCTGGCTCGCCTTAAAAGAG
TTAGCGTATTAACTTGTCGATCTGGCGTAATAAGTTTCGCTGGTGTAGAC
TTGAGAAGTGCGCTTCTAATCGTCTTCGGACAATTCTTGAACTCTGGTCT
CAAATCAGGTAGGACTACCCGCTGAACTTAAGCATATCAATAAGCGGAGG
A

### SEQUENCE LISTING

The instant application contains a Sequence Listing which has been submitted electronically in ASCII format and is hereby incorporated by reference in its entirety. Said ASCII copy, created on Nov. 27, 2015, is named 275.1-US-01_SL.txt and is 2,332 bytes in size.

1. A method of composting comprising:
(a) combining together:
organic matter comprising at least one of: leaves, stems, roots; fruits or seeds;
a Sphingobacterium species selected to:
comprise the DNA sequence of SEQ ID NO: 1; and
have an ability to utilize polyurethane as a sole carbon source; and
a polyurethane material;
(b) mixing the combination of (a);
(c) exposing the mixture of (b) to conditions suitable for microbial degradation of the combination of (a); such that the combination of (a) is composted.

2. The method of claim 1, wherein the polyurethane material is a polyurethane bag or a polyurethane bottle.

3. The method of claim 1, wherein the microorganism comprising SEQ ID NO: 1 is isolated from an environment at latitude 33.884736 and longitude −118.410909.

4. The method of claim 1, wherein the mixture is exposed to ambient environmental conditions in a Mediterranean climate for at least one month.

5. The method of claim 1, further comprising mixing the combination of (a) during compositing at least once a week.

6. The method of claim 1, wherein the mixture is disposed in a rotatable composting container.

7. The method of claim 1, further comprising mixing the combination of (a) with:
an Achromobacter species selected to:
comprise the DNA sequence of SEQ ID NO: 2; and
have an ability to utilize polyurethane as a sole carbon source.

8. The method of claim 7, further comprising mixing the combination of (a) with:
a Trichosporon species selected to:
comprise the DNA sequence of SEQ ID NO: 3; and
have an ability to utilize polyurethane as a sole carbon source.

9. The method of claim 8, wherein at least 10,000 microorganisms comprising SEQ ID NO: 1, SEQ ID NO: 2 or SEQ ID NO: 3 are added to the combination of (a).

10. The method of claim 8, wherein the microorganism comprising SEQ ID NO: 2 is isolated from an environment at latitude 33.884736 and longitude −118.410909.

11. A composting kit including a composition of matter comprising:
a Sphingobacterium species selected to:
comprise the DNA sequence of SEQ ID NO: 1; and
utilize polyurethane as a sole carbon source;
a polyurethane.

12. The kit of claim 11, further comprising an Achromobacter species selected to:
comprise the DNA sequence of SEQ ID NO: 2; and
have an ability to utilize polyurethane as a sole carbon source.

13. The kit of claim 12, further comprising a Trichosporon species selected to:
comprise the DNA sequence of SEQ ID NO: 3; and
have an ability to utilize polyurethane as a sole carbon source.

14. The kit of claim 13, wherein the composition comprises at least 10,000 microorganisms comprising SEQ ID NO: 1, at least 10,000 microorganisms comprising SEQ ID NO: 2 and at least 10,000 microorganisms comprising SEQ ID NO: 3.

15. The kit of claim 11, wherein the polyurethane is a polyurethane bag or a polyurethane bottle.
